(19) United States
(12) Patent Application Publication
(10) Pub. No.: US 2007/0241991 A1
(43) Pub. Date: Oct. 18, 2007

(54) Flat panel display and assembling method thereof

(75) Inventor: Yee-Hua Tsai, Taichung (TW)

Correspondence Address: RABIN & Berdo, PC, 1101 14TH STREET, NW, SUITE 500, WASHINGTON, DC, 20005, US

(73) Assignee: AU OPTRONICS CORP., Hsinchu (TW)

(21) Appl. No.: 11/525,871

(22) Filed: Sep. 25, 2006

(30) Foreign Application Priority Data
Apr. 13, 2006 (TW) 95113240

(51) Int. Cl. G09G 5/00; G02F 1/1333

(52) U.S. Cl. 345/7; 349/58

(57) ABSTRACT

A flat panel display including a display panel and a frame is provided. The outer edge of the display panel has a first combining portion, and the first combining portion has a guide angle. The inner edge of the frame has a second combining portion, and the second combining portion is complementary and interferes with the first combining portion in shape so as to fix the display panel on the frame.

This application claims the benefit of Taiwan Patent Application Serial No. 95113240, filed Apr. 13, 2006, the subject matter of which is incorporated herein by reference.

### BACKGROUND OF THE INVENTION

1. Field of the Invention

The invention relates in general to a flat panel display and an assembling method thereof, and more particularly to a flat panel display whose display panel has a combining portion complementary with a combining portion formed on the frame of the flat display and an assembling method thereof.

2. Description of the Related Art

In recent years, flat panel featured by small size, low weight, low radiation and low power consumption has gained great popularity in the display industry. With the advance in refresh frequency technology and the success in large-scale production of large sized panels, the flat panel display (FPD) has been used in home entertainment. Consequently, the production and economic scale of the panel keep increasing.

Conventionally, during the assembly of flat panel display, there are various ways of combining the panel with the frame. In terms of small sized panels, the panel is normally adhered onto the frame via a tape to form a display module. However, such a combining method has the following disadvantages. Under high temperature and high humidity, the tape expands and waves, and under low temperature, the adherence of the tape deteriorates. That is to say, under extreme environments, the reliability of the above combining method deteriorates. In terms of large size panels, an upper housing, a lower housing and a middle frame are normally incorporated together to fix the display panel. However, such a combining method has the following disadvantages. Too many assembly parts make the assembling step complicated. Furthermore, the display panel is lack of firm support in a display module, so the mechanical strength is weak and the panel is damaged easily. Moreover, frame shift may easily occur to the display panel due to assembly tolerance and fit tolerance.

### SUMMARY OF THE INVENTION

It is therefore an object of the invention to provide a flat panel display and assembling method thereof. A structure formed on the display panel interferes with a structure formed on the frame, such that the display panel can be firmly disposed in the frame and conveniently dismounted from the frame. Not only the influence of extreme environment such as high temperature, low temperature and high humidity is avoided but also assembly parts are saved.

The invention achieves the above-identified object by providing a flat panel display including a display panel and a frame. The outer edge of the display panel has a first combining portion, and the first combining portion has a guide angle. The inner edge of the frame has a second combining portion, and the second combining portion is complementary with the first combining portion in shape so as to fix the display panel on the frame.

The invention achieves the above-identified object by providing a method for assembling flat panel. Firstly, a display panel is provided, and a first combining portion having a guide angle is formed on the outer edge of the display panel. Next, a frame is provided. A second combining portion complementary with the first combining portion in shape is formed on the inner edge of the frame. Then, the first combining portion of the display panel is combined with the second combining portion of the frame so as to fix the display panel on the frame.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a display panel of flat panel display according to a preferred embodiment of the invention;

FIG. 2 is a frame of flat panel display according to a preferred embodiment of the invention;

FIG. 3 is a diagram of flat panel display after the display panel of FIG. 1 is combined with the frame of FIG. 2;

FIGS. 4A-4C illustrate three types of guide angles on the outer edge of the display panel; and

FIG. 5 illustrates a flowchart of a flat panel display assembling method of the invention.

### DETAILED DESCRIPTION OF THE INVENTION

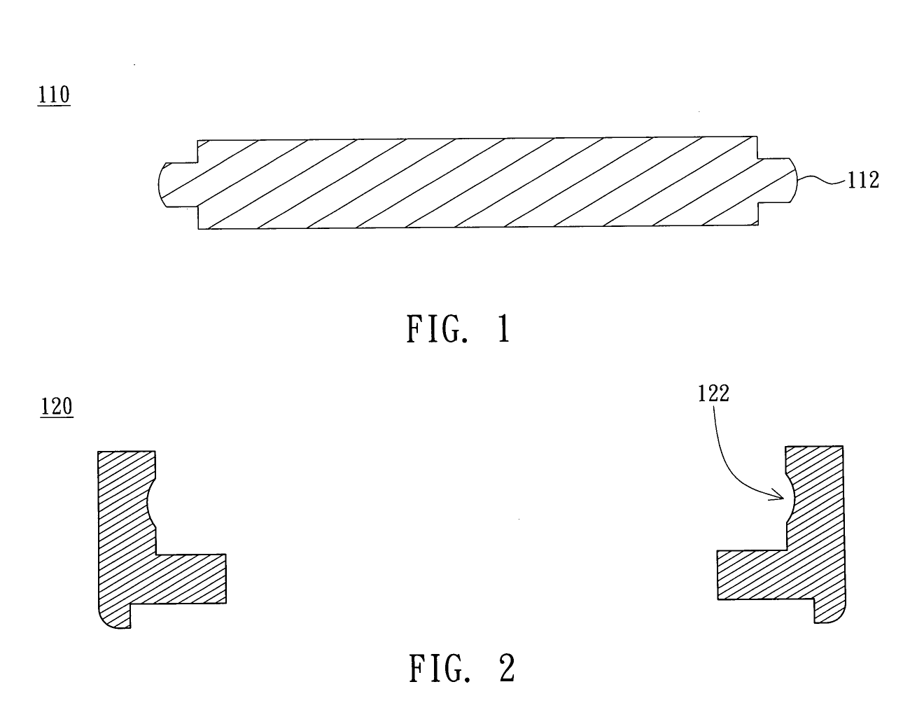

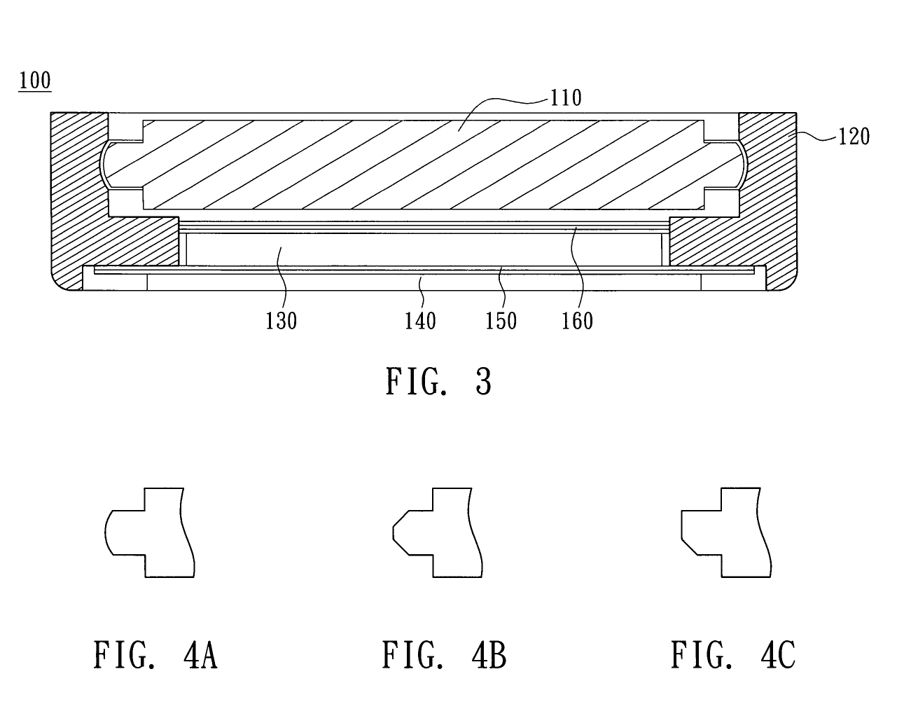

Referring to FIG. 1 and FIG. 2. FIG. 1 is a display panel of flat panel display according to a preferred embodiment of the invention. FIG. 2 is a frame of flat panel display according to a preferred embodiment of the invention. The outer edge of the display panel 110 has a first combining portion 112. The inner edge of the frame 120 has a second combining portion 122. In the present embodiment of the invention, the first combining portion 112 is a protrusion such as a round guide angle. And the second combining portion 122 is a recess such as a circular recess complementary with the first combining portion 112 in shape, such that the display panel 110 can be fixed on the frame 120. The first combining portion 112 and the second combining portion 122 can further interfere with each other so as to fix the display panel 110 on the frame 120 even firmly. Referring to FIG. 3, a diagram of flat panel display after the display panel of FIG. 1 is combined with the frame of FIG. 2 is shown. The flat panel display 100 includes a display panel 110, a frame 120, a backlight module 130, a bezel 140, a reflector 150 and an optical film 160. The bezel 140 is combined with the frame 120. The reflector 150 is adhered onto the bezel 140 and is positioned under the backlight module 130 for reflecting the light emitted from the backlight module 130. The backlight module 130 is positioned inside the inner edge of the frame 120. And the backlight module 130 is disposed in parallel to and underneath the display panel 110. A number of optical films 160 are assembled with the backlight module 130. The optical film 160 can be a diffuser, a prism, or a combination of diffusers and prisms. In the present embodiment of the invention, a prism is retained between two diffusers such that the uniformity and luminance of the light emitted from the backlight module 130 is improved. The material of the frame 120 includes plastics, rubber, zinc or iron capable of being temporarily deformed to accommodate the display panel 110. Furthermore, with the interference between the first combining portion 112 and the second combining portion 122, the display panel 110 is even firmly fixed on the frame 120.

Any one who is skilled in the technology of the invention will understand that the technology of the invention is not limited thereto. Referring to FIGS. 4A-4C, three guide angles on the outer edge of the display panel are shown. The guide angle can be either a circular angle as shown in FIG. 4A, a polygonal bevel angle as shown in FIG. 4B, or a bevel angle as shown in FIG. 4C.

Besides, examples of the display panel 110 include a liquid crystal display panel and an organic electroluminescent light display (OELD) panel.

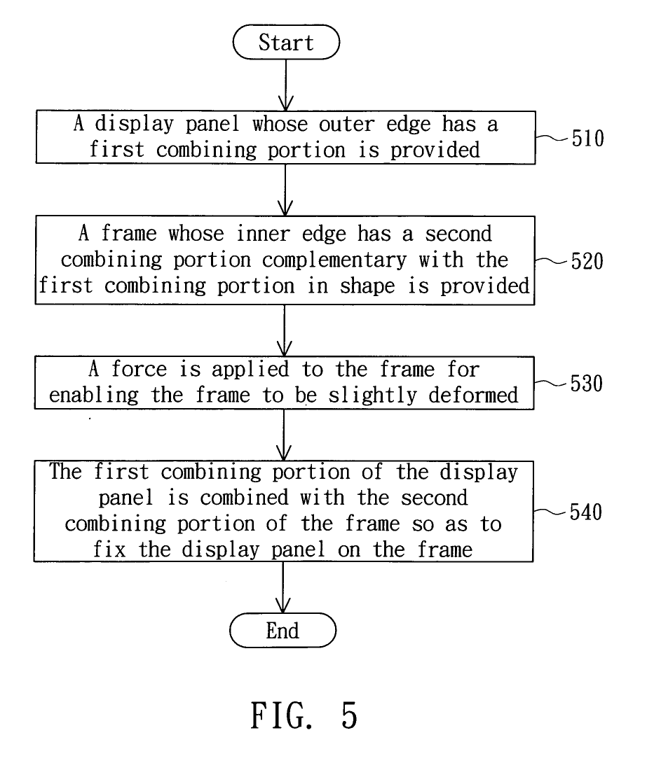

A method for assembling flat display is provided according to the above method for combining the display panel 110 and the frame 120. Referring to FIG. 5, a flowchart of a flat display assembling method of the invention is shown. Firstly, the method begins at step 510, a display panel 110 whose outer edge has a first combining portion 112 having a guide angle is provided. Next, proceed to step 520, a frame 120 whose inner edge has a second combining portion 122 complementary with the first combining portion 112 in shape is provided. Then, proceed to step 530, a force can be applied to the frame 120 for enabling the frame 120 to be slightly deformed. Next, proceed to step 540, the first combining portion 112 of the display panel 110 is combined with the second combining portion 122 of the frame 120 so as to fix the display panel 110 on the frame 120.

Any one who is skilled in the technology of the invention will understand that the technology of the invention is not limited thereto. For example, the first combining portion having a guide angle 112 can be formed by various mechanical processing methods such as canting, cutting and grinding. The frame 120 and the second combining portion 122 are formed by filling or injecting plastics into a designed mold. Otherwise, the second combining portion 122 is formed by bending the frame 120.

According to the flat panel display and assembling method thereof disclosed in the above embodiment of the invention, the display panel and the frame are processed machnically to form structures thereon respectively which interferes with each ohter, such that the display panel can be firmly disposed in the frame and conveniently dismounted from the frame. Even under extreme environment such as high temperature, low temperature and high humidity, the display panel and the frame are still combined together with an excellent reliability, saving both assembly parts and manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flat panel display, comprising:
a display panel having a first combining portion in the outer edge thereof, the first combining portion having a guide angle; and
a frame having a second combining portion in the inner edge thereof, the second combining portion being complementary with the first combining portion in shape so as to fix the display panel on the frame.

2. The flat panel display according to claim 1, wherein the second combining portion interferes with the first combining portion in shape.

3. The flat panel display according to claim 1, wherein the first combining portion is a protrusion while the second combining portion is a recess.

4. The flat panel display according to claim 1, wherein the guide angle is a circular angle.

5. The flat panel display according to claim 1, wherein the guide angle is a bevel angle.

6. The flat panel display according to claim 1, wherein the guide angle is a polygonal bevel angle.

7. The flat panel display according to claim 1, wherein the frame is made of plastics, rubber, zinc, or iron.

8. The flat panel displayaccording to claim 1, wherein the display panel comprises a liquid crystal display panel.

9. The flat panel display according to claim 1, wherein the display panel comprises an organic electroluminescent light display (OELD).

10. The flat panel display according to claim 1, further comprising a backlight module positioned inside the inner edge of the frame, and the backlight module is disposed underneath the display panel.

11. A method for assembling flat panel display, comprising:
providing a display panel having a first combining portion in the outer edge thereof, the first combining portion having a guide angle;
providing a frame havinga second combining portion in the inner edge thereof, the second combining portion being complementary with the first combining portion in shape; and
combining the first combining portion of the display panel with the second combining portion of the frame so as to fix the display panel on the frame.

12. The method according to claim 11, further comprising applying a force to the frame such that the frame is deformed.

13. The method according to claim 11, wherein the first combining portion interferes with the second combining portion.

14. The method according to claim 11, wherein the first combining portion is fabricated by canting, cutting, and grinding.

15. The method according to claim 11, wherein the frame and the second combining portion are formed by mold filling.

16. The method according to claim 11, wherein the frame and the second combining portion are formed by injection molding.

17. The method according to claim 11, wherein the second combining portion is formed by bending.
